(19) United States
(12) Patent Application Publication
(10) Pub. No.: US 2012/0322288 A1
(43) Pub. Date: Dec. 20, 2012

(54) ELECTRICAL CONNECTOR AND TERMINAL THEREOF

(75) Inventors: RONG-QIN LAN, NEW TAIPEI (TW); LI-JUN XU, NEW TAIPEI (TW)

(73) Assignee: CHENG UEI PRECISION INDUSTRY CO., LTD., New Taipei City (TW)

(21) Appl. No.: 13/161,016

(22) Filed: Jun. 15, 2011

(51) Int. Cl. H01R 13/62

(52) U.S. Cl. 439/345

(57) ABSTRACT

An electrical connector includes an insulating body and a plurality of terminals assembled in the insulating body. The terminal has a fastening strip of which a bottom end is bent towards one side of the fastening strip and then protrudes rearward to form a soldering portion. A top end of the fastening strip is bent towards the other side of the fastening strip and then extends forward to form a first contact portion which has a front end thereof arched upward to project out of the insulating body for electrically connecting with one circuit. A second contact portion is formed at a substantial middle of a front edge of the fastening strip and further exposed outside the insulating body for electrically connecting with another circuit.

### BACKGROUND OF THE INVENTION

1. Field of the Invention

The present invention relates to a connector, and more particularly to an electrical connector and terminals thereof

2. The Related Art

A traditional electrical connector includes an insulating body and a plurality of terminals assembled in the insulating body. Each of the terminals has a fastening strip, a contact portion and a soldering portion which are bent and extended from two opposite ends of the fastening strip. The contact portion can be connected with a circuit to realize a signal transmission. However, the foregoing terminal has only one contact portion for only achieving one signal transmission each time. As a result, a transmission of branch signals among many circuits having the same functions will be realized by means of many forgoing electrical connectors cooperating with the circuits respectively. It results in a complicated structure, and needs a large space for the electrical connectors and the circuits and greater costs for simultaneously realizing the transmission of branch signals from many circuits.

### SUMMARY OF THE INVENTION

An object of the present invention is to provide an electrical connector and terminals of the electrical connector. The electrical connector includes an insulating body, and the terminals assembled in the insulating body. The terminal has a fastening strip of which a bottom end is bent towards one side of the fastening strip and then protrudes rearward to form a soldering portion. A top end of the fastening strip is bent towards the other side of the fastening strip and then extends forward to form a first contact portion which has a front end thereof arched upward to project out of the insulating body. A second contact portion is formed at a substantial middle of a front edge of the fastening strip and further exposed outside the insulating body.

As described above, the terminal of the present invention utilizes the first contact portion and the second contact portion to electrically connect with two external circuits having same functions so as to achieve the transmission of branch signals from the two circuits simultaneously. So the electrical connector of the present invention has a simple structure. It further needs a smaller space for the electrical connector and the circuits, and reduces costs for simultaneously achieving the transmission of branch signals from many circuits.

### BRIEF DESCRIPTION OF THE DRAWINGS

The present invention will be apparent to those skilled in the art by reading the following description thereof, with reference to the attached drawings, in which:

FIG. 1 is an assembled perspective view of an electrical connector according to an embodiment of the present invention;

FIG. 2 is an exploded perspective view of the electrical connector of FIG. 1; and

FIG. 3 is a perspective view of an insulating body of the electrical connector of FIG. 1.

### DETAILED DESCRIPTION OF THE PREFERRED EMBODIMENT

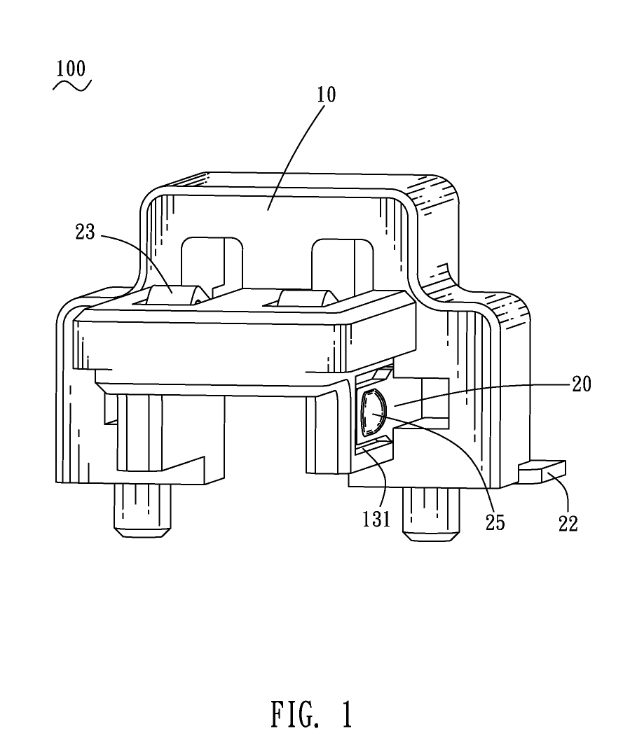

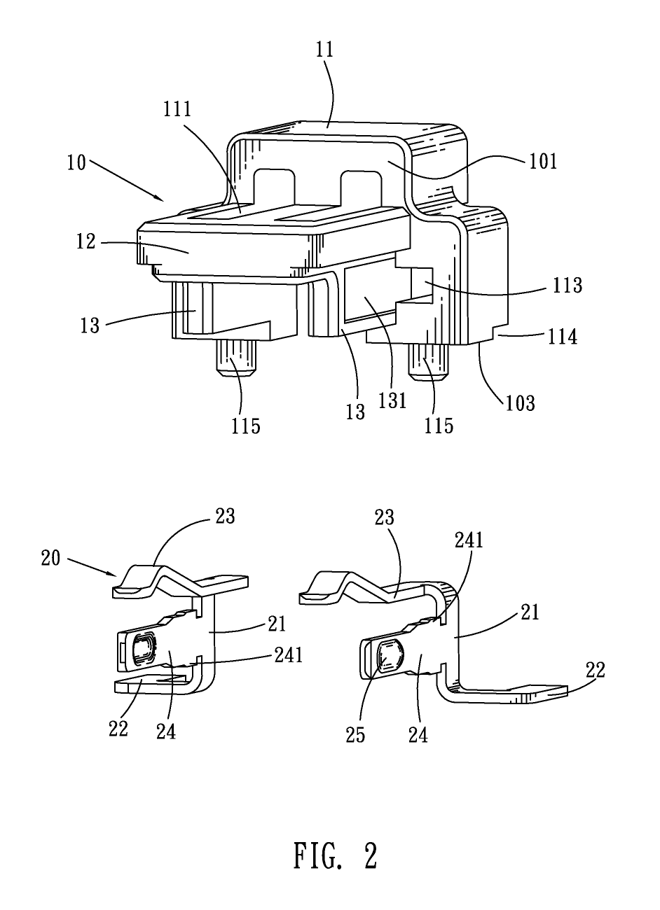

With reference to FIG. 1 and FIG. 2, an electrical connector 100 according to an embodiment of the present invention includes an insulating body 10 and a plurality of terminals 20 mounted in the insulating body 10 respectively.

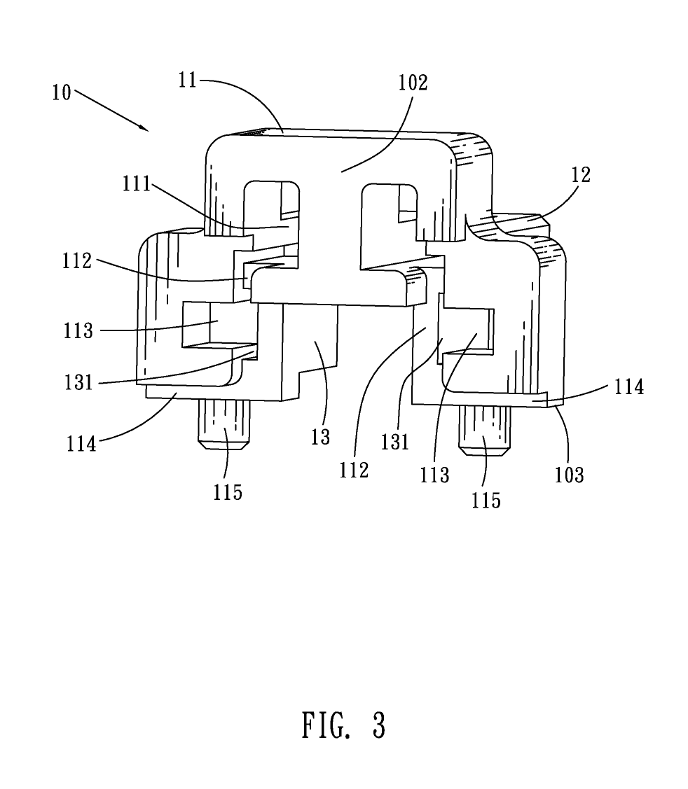

Referring to FIGS. 2-3, the insulating body 10 has a base portion 11 disposed vertically, of which a middle of a front surface 101 protrudes forward to form a tongue portion 12. Two sides of a bottom of the tongue portion 12 protrude downward to form two support boards 13 each extending along the extension direction of the tongue portion 12 and further connected with the front surface 101 of the base portion 11. A top of the tongue portion 12 defines two receiving fillisters 111 each extending along a front-to-rear direction of the tongue portion 12 and further penetrating rearward through the base portion 11. Two fastening fillisters 112 are opened in a rear surface 102 of the base portion 11 and spaced from each other. Each of the fastening fillisters 112 extends vertically to have an inside of a top end thereof connected with an outside of one receiving fillister 111. Two bottom ends of the two fastening fillisters 112 oppositely extend outside to form two receiving grooves 114 exposed through a bottom surface 103 of the base portion 11. Two opposite outsides of the two support boards 13 respectively define a substantially rectangular receiving cavity 131 further extending rearward to the base portion 11 and connected with a substantial middle of the corresponding fastening fillister 112. Two passages 113 are opened in the base portion 11 and located at two opposite sides of the two support boards 13. Each of the passages 113 penetrates through the front surface 101 and the rear surface 102 of the base portion 11, and has an inside thereof connected with middles of the corresponding fastening fillister 112 and a rear of the corresponding receiving cavity 131. Two ends of the bottom surface 103 of the base portion 11 protrude downward to form two locating pillars 115 assisting the insulating body 10 to be secured to an external product (not shown).

Referring to FIG. 2 again, each of the terminals 20 has a fastening strip 21 extending vertically, of which a top end is bent towards one side of the fastening strip 21 and then extends forward to form a first contact portion 23 having a front end thereof arched upward. A bottom end of the fastening strip 21 is bent towards the other side of the fastening strip 21 and then protrudes rearward to form a soldering portion 22. A middle of a front edge of the fastening strip 21 extends forward to form a support arm 24 of which top and bottom edges oppositely protrude to form a plurality of lumps 241. A front of the support arm 24 is punched towards one side of the support arm 24 opposite to the first contact portion 23 to form a second contact portion 25.

Referring to FIGS. 1-3, in assembly, the terminals 20 are inserted forward into the insulating body 10 with the fastening strips 21 being vertically fastened in the fastening fillisters 112 respectively. The support arm 24 is inserted in the receiving cavity 131 of the corresponding support board 13 and the lumps 241 abut against top and bottom sides of the receiving cavity 131 to firmly secure the terminal 20 with the insulating body 10, with the second contact portion 25 exposed outside from the receiving cavity 131. The first contact portion 23 is received in the corresponding receiving fillister 111 and further projects upward out of the receiving fillister 111. The soldering portion 22 is disposed in the receiving groove 114. In the process of the support arm 24 being inserted forward into the receiving cavity 131, the passage 113 is designed for the convenience of the second contact portion 25 passing therethrough to avoid the second contact portion 25 being damaged.

In use, the first contact portion 23 and the second contact portion 25 of one of the terminals 20 can be electrically connected with two external circuits (not shown) having same functions respectively so as to simultaneously achieve the transmission of branch signals from the circuits.

As described above, the electrical connector 100 of the present invention utilizes the first contact portion 23 and the second contact portion 25 of the terminal 20 to electrically connect with two external circuits having the same functions respectively so as to achieve the transmission of branch signals from the two circuits simultaneously. So the electrical connector 100 of the present invention has a simple structure. It further needs a smaller space for the electrical connector 100 and the circuits, and reduces costs for simultaneously achieving the transmission of branch signals from many circuits.

What is claimed is:

1. An electrical connector, comprising:
an insulating body; and
a plurality of terminals assembled in the insulating body, each of the terminals having a fastening strip of which a bottom end is bent towards one side of the fastening strip and then protrudes rearward to form a soldering portion, a top end of the fastening strip being bent towards the other side of the fastening strip and then extending forward to form a first contact portion which has a front end thereof arched upward to project out of the insulating body, a second contact portion being formed at a substantial middle of a front edge of the fastening strip and further exposed outside the insulating body.

2. The electrical connector as claimed in claim 1, wherein the substantial middle of the front edge of the fastening strip extends forward to form a support arm, the second contact portion is formed on a front of the support arm.

3. The electrical connector as claimed in claim 2, wherein the second contact portion is formed by the front of the support arm being punched towards one side of the support arm opposite to the first contact portion.

4. The electrical connector as claimed in claim 2, wherein the insulating body has a base portion, a tongue portion protruding forward from a front surface of the base portion, and two support boards protruding downward from two sides of a bottom of the tongue portion, a top of the tongue portion defines two receiving fillisters each extending rearward to penetrate through the base portion, two ends of a bottom surface of the base portion respectively define a receiving groove, two fastening fillisters are opened in a rear surface of the base portion and each extends vertically to connect the receiving fillister and the corresponding receiving groove, an outside of each support board defines a receiving cavity further extending rearward to be connected with a substantial middle of the corresponding fastening fillister, the fastening strip of the terminal is vertically fastened in the fastening fillister, the support arm is inserted in the receiving cavity of the corresponding support board with the second contact portion exposed outside from the receiving cavity, the first contact portion is received in the receiving fillister and further projects upward out of the receiving fillister, and the soldering portion is disposed in the receiving groove.

5. The electrical connector as claimed in claim 4, wherein the base portion further defines two passages located at two opposite sides of the two support boards, each of the passages penetrates through the base portion along the front-to-rear direction, and has an inside thereof connected with middles of the corresponding fastening fillister and a rear of the corresponding receiving cavity, for the convenience of the second contact portion passing therethrough to avoid the second contact portion being damaged in the process of the support arm being inserted forward into the receiving cavity.

6. The electrical connector as claimed in claim 4, wherein top and bottom edges of the support arm of the terminal oppositely protrude to form a plurality of lumps abutting against top and bottom sides of the receiving cavity to secure the terminal with the insulating body.

7. The electrical connector as claimed in claim 4, wherein the two ends of the bottom surface of the base portion protrude downward to form two locating pillars.

8. A terminal adapted to connect with two circuits simultaneously, comprising:
a fastening strip;
a soldering portion formed by a bottom end of the fastening strip being bent towards one side of the fastening strip and then protruding rearward;
a first contact portion formed by a top end of the fastening strip being bent towards the other side of the fastening strip and then extending forward with a front end arched upward, for electrically connecting with one of the two circuits; and
a second contact portion formed at a substantial middle of a front edge of the fastening strip, for electrically connecting with the other circuit.

9. The terminal as claimed in claim 8, wherein the substantial middle of the front edge of the fastening strip extends forward to form a support arm, the second contact portion is formed on a front of the support arm.

10. The terminal as claimed in claim 9, wherein the second contact portion is formed by the front of the support arm being punched towards one side of the support arm opposite to the first contact portion.
